(19) United States
(12) Patent Application Publication
(10) Pub. No.: US 2005/0218823 A1
(43) Pub. Date: Oct. 6, 2005

(54) Camera flash apparatus using ultraviolet light for triggering of the flash tube

(75) Inventor: David R. Dowe, Holley, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/818,223

(22) Filed: Apr. 5, 2004

(51) Int. Cl. H05B 37/00

(52) U.S. Cl. 315/200 R

(57) ABSTRACT

A camera flash apparatus having a flash tube enclosing a pair of electrodes in an ultraviolet light transparent envelope containing gas molecules normally presenting a high impedance between the electrodes. An ultraviolet light source directed at the tube is actuated at the start of a flash picture-taking event to ionize at least some of the gas in the envelope lowering the internal resistance of the tube to allow a flash energy source coupled to the electrodes to discharge through the flash tube. A flash unit incorporating the ultraviolet source is also disclosed

### FIELD OF THE INVENTION

The present invention relates to a method and apparatus for discharging a flash tube and, more particularly, to such a method and apparatus wherein ultraviolet light is used in triggering the flash tube to emit flash light.

### BACKGROUND OF THE INVENTION

A plasma can be generated in a gas by ionizing the gas molecules. In a xenon flash tube typically used for flash photography, a filamentary plasma is generated to create an energy discharge from the anode to the cathode of the flash tube. This energy discharge, in turn, creates a brilliant flash of white light used to illuminate the scene or subject being photographed. The method used to create the filamentary plasma is accomplished by initially ionizing the xenon gas by use of a high voltage source. To generate this high voltage, a component known as a trigger transformer is used to convert a lesser voltage pulse on its primary winding to a much higher voltage on its secondary winding, on the order of 4500 volts, which is then applied to the tube.

FIG. 1 shows a basic flash circuit 10 for operating a flash tube 12 with a conventional external trigger wire 13. A storage capacitor 14 and a trigger capacitor 16 are charged by a voltage source 18. A high valued resistor 20 serves as a current limiter that allows trigger capacitor 16 to be charged to its proper potential while limiting current flow to trigger capacitor 16 during flashing. When a trigger switch 22 is closed, trigger capacitor 16 discharges through the primary winding 24p of a trigger transformer 24, thus producing a high voltage pulse of 4500 v in the secondary winding 24s which is applied to the external trigger wire 13. The high voltage trigger pulse excites and/or ionizes molecules of gas in the flash tube 12, which greatly lowers the impedance between the flash tube electrodes 12a and 12b. Once this impedance is lowered, the flash voltage stored on capacitor 14 discharges through flash tube 12. This voltage discharge causes electron flow through flash tube 12 which excites some of the electrons of the gas molecules to a higher energy state while other electrons are removed completely (ionized) from the gas molecules. When these electrons return to the ground state, energy is released in the form of light which produces the brilliant flash of light for photography.

External triggering of the flash tube 12 with a trigger wire suffers from certain practical disadvantages. The trigger wire coming from the trigger transformer needs to be placed in close proximity to the flash tube glass envelope and spurious arcing from the external trigger wire 13 to adjacent components of the flash tube apparatus can occur. Also the glass envelope of the flash tube needs to have a conductive coating on it to distribute the high voltage from the trigger transformer across the flash tube and discoloration of the envelope of the flash tube 12 can be created due to the high voltage applied to the tube envelope. Also, relatively poor triggering reliability can result, especially at lower trigger voltages. Another drawback is that arcing of the high voltage from the trigger transformer has to be suppressed otherwise no flash from the flash tube will occur.

To solve problems of this sort, it is known that the flash tube 12 can be triggered in a series-injection mode of operation as illustrated by the circuit of FIG. 2. The circuit 10′ of FIG. 2 is similar to that of FIG. 1 except that the flash tube 12′ does not utilize an external trigger wire and does not have an external trigger coating, the output of trigger transformer secondary winding 24s being connected directly across the electrode terminals 12a′ and 12b′ of tube 12′. When the trigger switch 22 is closed, the high voltage pulse from secondary winding 12s is applied directly across the electrode terminals 12a′ and 12b′ and produces a strong arc across the electrodes, thereby lowering the impedance between the tube electrodes to allow the flash charge on storage capacitor 14 to discharge through the flash tube 12.

Applying the high voltage trigger pulse directly to the flash tube electrodes places extreme stress on these electrodes which can lead to early tube failure. Moreover, in actual practice, injection triggering adds inductance in the discharge path, thereby increasing the time duration of the flash and reducing peak intensity of light output.

It is known in industry and educational institutions that plasmas can also be created in the gas of interest by exposure to light. For example, exposure to Vacuum Ultraviolet (VUV) light will cause xenon gas to ionize. Such uses for ionized xenon gas are for inducing continuum structures, high resolution spectroscopy, or for secondary ionization of another gas such as used in the purification of flue gases.

In Patent Application Publication No. U.S. 2002/0074559 A1, published Jun. 20, 2002, ultraviolet light emitting diodes (UVLEDs) are described as being used in a pulsing or flashing mode on a camera to create different effects or for power supply conservation. Direct exposure of the UVLED to the subject as the primary flash light or for special effects would not be appropriate for general photography use.

### SUMMARY OF THE INVENTION

In accordance with the invention, therefore, camera flash apparatus is provided which comprises a flash tube having a pair of electrodes in an ultraviolet light transparent envelope containing gas molecules normally presenting a high impedance between the electrodes. The apparatus further comprises a trigger circuit which includes an ultraviolet light source adjacent the envelope and a switch for actuating the ultraviolet light source to ionize the gas molecules in the tube so as to lower the impedance between the electrodes. The apparatus also comprises a flash energy storage circuit coupled to the flash tube electrodes to fire the tube by discharging through the lowered impedance between the electrodes.

### BRIEF DESCRIPTION OF THE DRAWINGS

FIG. 1 is a schematic diagram of a prior art circuit illustrating a commonly used form of a camera flash tube trigger circuit;

FIG. 2 is a schematic diagram of a prior art circuit illustrating a series injection form of flash tube trigger circuit;

FIG. 3 is a schematic diagram of a camera flash circuit embodying an ultraviolet light flash tube trigger in accordance with the present invention;

FIG. 4 is a schematic diagram of a prior art circuit utilizing a simmer circuit conjunction with a series injection trigger circuit;

FIG. 5 is a schematic diagram of a camera flash circuit utilizing a simmer circuit in conjunction with an ultraviolet light trigger in accordance with another form of the present invention;

FIG. 6 is a schematic illustration of a flash apparatus utilizing an ultraviolet in accordance with the invention; and

FIG. 7 is a schematic illustration of an alternative embodiment of the invention utilizing an ultraviolet light flash tube trigger.

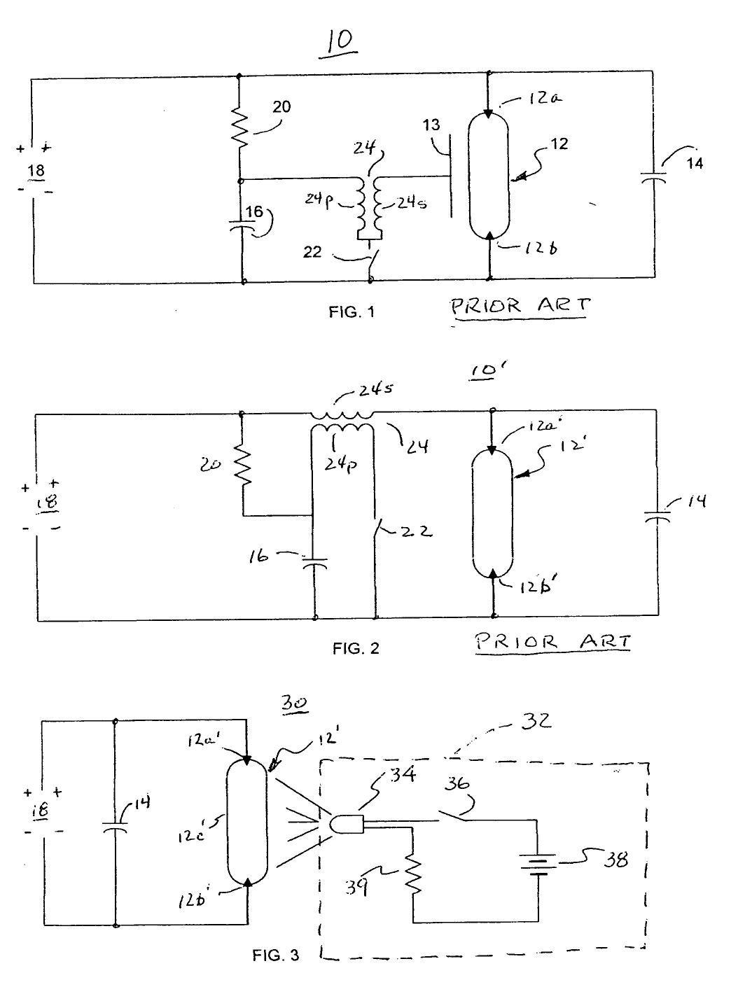

### DETAILED DESCRIPTION OF THE INVENTION

Turning now to FIG. 3, a camera flash circuit 30 according to one aspect of the invention includes a flash tube 12′ having a pair of electrodes 12a′ and 12b′ in an ultraviolet light transparent envelope 12c′, the envelope containing gas molecules, e.g. xenon gas, normally presenting a high electrical impedance between the electrodes. Flash tube 12′ of circuit 30 is similar to flash tube of 12′ of FIG. 2 in that it does not have an external trigger coating or any trigger wire associated therewith. Quartz is an ultraviolet transparent material suitable for use as the envelope 12c′ and, in fact, is commonly used for conventional flash tubes. A flash energy storage circuit, comprises an energy storage capacitor 14 which is charged by an energy source 18 to a suitable flash voltage level of approximately 330 v. Storage capacitor 14 is coupled to the flash electrodes 12a′ and 12b′ to fire the tube 12′ by discharging stored energy from capacitor 14 when the electrical impedance of the gas in the tube is lowered. A trigger circuit 32 used to lower the gas impedance in accordance with the invention includes an ultraviolet light source 34 positioned adjacent the tube envelope 12c′, an energy source 38, such as a battery, and a trigger switch 36 for actuating the ultraviolet light source from the battery 38. A resistor 39 serves as a current limiter in the trigger circuit. Battery 38 may be the same battery as that normally used in energy source 18 to charge storage capacitor 14. In a camera application, switch 36 is preferably coupled to a shutter actuating button or to the shutter itself to be closed when the shutter is opened to take a flash picture. A suitable ultraviolet light source may be a light emitting diode (UVLED) of the type described in aforementioned Patent Application U.S. 2002/0074559 A1. There is a range of wavelengths which produce optimum ionization results which depends, in part, on the gas purity and temperature. The ultraviolet wavelength range can fall between 100 nm and 400 nm. Optimum ultraviolet wavelengths for gas ionization are closest to the 100 nm range.

In operation, voltage source 18 charges storage capacitor 14 to a typical voltage level of approximately 330 v. Capacitor 14 does not initially discharge through the flash tube 12′ because the enclosed xenon gas has near infinite electrical impedance. When trigger switch 36 is closed upon opening of the camera shutter, ultraviolet light source 34 is activated and the ultraviolet light thus produced is directed at flash tube 12′. The applied ultraviolet light excites and ionizes gas molecules within the envelope of the flash tube thereby lowering the impedance between the flash tube electrodes 12a′ and 12b′ to the point of conduction. A burst of voltage from the storage capacitor 14 then discharges through flash tube 12′ causing the tube to fire.

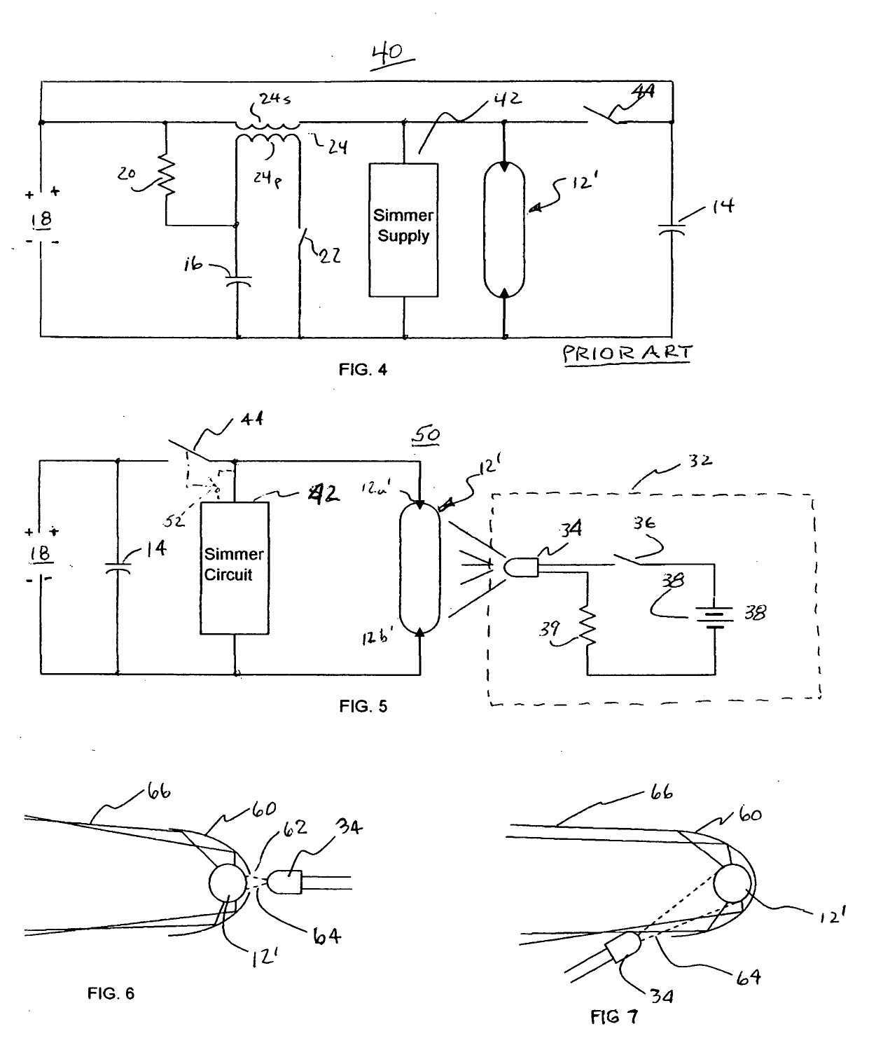

FIG. 4 shows a circuit 40 for firing a flash tube in a simmer mode of operation known to be useful in high speed flash photography. Circuit 40 is similar to that of FIG. 2 and corresponding components bear the same reference numerals. The differences are that a simmer supply 42 has been added in parallel with flash tube 12′, and a flash enable switch 44 is inserted between flash capacitor 14 and the flash tube 12′. It will be appreciated that in high speed flash operation, switches 36 and 44 would most likely take the form of SCR devices in known manner. Trigger switch 22 is arranged to be closed separately from and in advance of the closure of flash enable switch 44. Initially, trigger capacitor 16 and flash capacitor 14 are charged by voltage source 18 to the flash voltage of 330 v. When trigger switch 22 is closed, trigger capacitor 16 discharges through the primary winding 24p of the trigger transformer 24, and produces a high voltage pulse of about 4500 v across the secondary winding 24s. This high voltage trigger pulse is applied directly across the electrodes 12a′ and 12b; of the flash tube 12; and lowers the impedance between the tube electrodes, as previously described for the circuit of FIG. 2. Because of the lowered impedance between the electrodes, the simmer supply 42 is able to establish a low current dc arc between the electrodes. Typically, the current of such a simmer arc is on the order of 20-100 ma. When it is desired to fire the tube 12′, flash enable switch 44 is closed and a flash voltage from the storage capacitor 14 discharges through tube 12′ producing the desired flash of light. Under ideal operating conditions, the simmer arc will not be extinguished upon firing of the flash tube and the tube can be repetitively fired by merely closing the switch 44 as the storage capacitor 14 is charged.

To completely eliminate the use of a high voltage trigger pulse and the attendant adverse affects upon tube life, the present invention provides a circuit 50, shown in FIG. 5, for operating a flash tube in the simmer mode. In this circuit, the voltage injection trigger circuit of FIG. 4 is replaced with the ultraviolet light trigger circuit 32 of FIG. 3. A source of ultraviolet light 20 is activated by trigger switch 36 and the ultraviolet light thus produced is directed at flash tube 12′. As previously described, the applied ultraviolet light excites and ionizes gas molecules within the envelope of the flash tube thereby lowering the impedance between the flash tube electrodes 12a′ and 12b′ to the point of conduction. Simmer supply 42 then establishes a simmer arc between the tube electrodes 12a′ and 12b′. Firing of the flash tube is accomplished by closing the flash enable switch 44 which allows the storage capacitor 14 to discharge through flash tube 12′. In the event that the simmer arc is extinguished, either due to the firing of the flash tube or because of excessive heat build up, it is a simple matter to retrigger the simmer arc by applying another pulse of ultraviolet light from trigger circuit 32. Thus, the high voltage trigger pulse which adversely effects tube life is eliminated entirely.

Because the present invention provides a method of initiating the simmer arc without the use of a high voltage trigger pulse, the flash tube can now be operated much with less power and produces substantially less heat. In accordance with the invention, the simmer power supply is purposefully operated so that the simmer arc will be extinguished upon firing of the flash tube. This can be done by reducing the current of the simmer arc to a marginal value such that the arc is “blown out” upon the main discharge. Alternatively, a simmer arc switch 52 (shown in dotted line form) may be substituted in the simmer supply circuit 42 leading to flash tube electrode 12a′ and coupled in tandem with switch 44 to open the simmer supply as flash tube 12′ is discharged and to then close when switch 44 is reopened.

In operation, therefore, when a pulse of ultraviolet light from the ultraviolet light source 34 is directed at flash tube 12, the impedance of flash tube 12′ is lowered and a simmer arc is then established between the flash tube electrode 12a′ and 12b′. When switch 44 is closed and the simmer arc switch 52 is opened, the flash voltage on the storage capacitor 14 is discharged through the flash tube causing the tube to fire and the simmer arc to be extinguished. The flash enable switch 44 is then opened and the simmer arc switch 52 is closed while the capacitor 14 recharges. Even though the simmer switch is now closed, the simmer arc is not re-established because of the high internal impedance of the tube 12′. When it is desired to re-fire the flash tube, trigger switch 36 is closed and another pulse of ultraviolet light from the ultraviolet light source 34 is applied to flash tube 12′ to lower the impedance between the electrodes 12a′ and 12b′. The simmer arc is thus re-established and the switch 44 can again be closed to cause the storage capacitor 14 to discharge through the flash tube.

In this embodiment, switches 36 and 44 may be actuated by a two stage shutter release button in which initial pressing of the button during the first stage closes trigger switch 36 to initiate the simmer arc. Pressing the button further into the second stage then closes flash enable switch 44 allowing the flash storage capacitor 14 to discharge through the flash tube 12′ simmer arc. Because the simmer arc is not maintained between flashes, less power is used by the simmer supply and less heat is produced by the flash tube. Importantly, however, because the simmer arc is re-established by means of a pulse of ultraviolet light rather than a high voltage trigger pulse, tube life is extended.

In FIG. 6, one possible placement of the ultraviolet light source is shown for a camera flash unit. In this arrangement, the ultraviolet light source, such as the aforementioned UVLED, is positioned behind the flash reflector 60 and in alignment with an aperture 62 formed in the rear of the reflector so that the UV light rays 64 shine through the aperture 62 directly onto the flash tube 12′. Flash light rays 66 are then emitted directly forward of the reflector without being impeded by the UVLED 34.

In FIG. 7, another placement for the UVLED is shown in which the UVLED 34 is placed in front of the flash reflector in an off-axis position in which the UVLED has minimal obstruction to the emission of flash light 64 when flash tube 12′ is triggered and the white light is reflected off of reflector 60.

The invention has been described in detail with particular reference to certain preferred embodiments thereof, but it will be understood that variations and modifications can be effected within the spirit and scope of the invention.

PARTS LIST

| | |
|---|---|
| 10. | prior art camera flash circuit |
| 12. | flash tube |
| 13. | external trigger wire |
| 14. | flash storage capacitor |
| 16. | trigger capacitor |
| 18. | voltage source |
| 20. | current limiting resistor |
| 22. | trigger switch |
| 24. | trigger transformer |
| 30. | camera flash apparatus (FIG. 3) |
| 32. | UV flash trigger circuit |
| 34. | UV light source |
| 36. | trigger switch |
| 38. | battery |
| 39. | current limiting resistor |
| 40. | camera flash apparatus (FIG. 4) |
| 42. | simmer supply circuit |
| 44. | flash enable switch |
| 50. | camera flash apparatus (FIG. 5) |
| 52. | simmer arc switch |
| 60. | flash reflector |
| 62. | reflector aperture |
| 64. | ultraviolet rays |
| 66. | flash light rays |

1. Camera flash apparatus comprising:
a flash tube having a pair of electrodes in an ultraviolet light transparent envelope containing gas molecules normally presenting a high impedance between the electrodes;
a trigger circuit including an ultraviolet light source adjacent the envelope and including a switch for actuating the ultraviolet light source to ionize the gas molecules in the tube so as to lower the impedance between the electrodes; and
a flash energy storage circuit coupled to the flash tube electrodes to fire the tube by discharging through the lowered impedance between the electrodes.

2. Apparatus according to claim 1, wherein said trigger circuit further includes a simmer voltage supply circuit coupled to the tube electrodes to generate a simmer voltage discharges through the flash tube to create a low current arc through the tube electrodes; and the flash energy storage device discharges through the low current arc between the tube electrodes.

3. Apparatus according to claim 2, wherein said flash energy storage circuit includes a flash enable switch adapted to be closed after the simmer arc is established to allow discharge of the flash energy through the simmer arc.

4. Apparatus according to claim 3, further including a two stage shutter release button and wherein said trigger circuit switch and said flash enable switch are coupled to said shutter release button to close the trigger switch during the first stage and to close the flash enable switch during the second stage.

5. An improved flash apparatus for a camera including a flash tube having a pair of electrodes in an ultraviolet light transparent envelope containing gas molecules normally presenting a high impedance between the electrodes; a flash energy storage circuit coupled to the flash tube electrodes to fire the tube by discharging through a lowered impedance between the electrodes; and a trigger circuit to ionize the gas molecules in the tube so as to lower the impedance between the electrodes;
the improvement comprising:
the trigger circuit having an ultraviolet light source adjacent the envelope and used to ionize the gas molecules in the flash tube.

6. The improved flash apparatus of claim 5, wherein the improvement further comprises:
a simmer circuit for establishing a low current arc through the gas molecules ionized by the ultraviolet light source, the flash energy source thereby being enabled to discharge through the low current arc in the flash tube.

7. For use in a camera flash apparatus, a flash unit comprising:
a flash tube having a pair of electrodes in an ultraviolet light transparent envelope containing gas molecules normally presenting a high impedance between the electrodes;
a flash light reflector for directing flash light generated by the flash tube outwardly toward a scene to be photographed; and
an ultraviolet light source positioned to direct ultraviolet light at the flash tube to ionize the gas modules in the flash tube to lower the impedance of the gas molecules.

8. The flash unit of claim 7, said reflector has an aperture formed therein adjacent the flash tube and the ultraviolet light source is positioned to direct ultraviolet light through the aperture onto the gas molecules in the flash tube.

9. The flash unit of claim 7, said ultraviolet light source is located in front of the reflector in an off-axis position in which the ultraviolet light directs ultraviolet light onto the gas molecules in the flash tube with minimal obstruction to flash light reflected by the reflector.
